(19) United States
(12) Patent Application Publication
(10) Pub. No.: US 2026/0185525 A1
(43) Pub. Date: Jul. 2, 2026

(54) ELECTRIC COMPRESSOR

(71) Applicant: Hanon Systems, Daejeon (KR)

(72) Inventors: Ok Hyun Kim, Daejeon (KR); Se Young Song, Daejeon (KR)

(21) Appl. No.: 18/858,622

(22) PCT Filed: Apr. 12, 2023
(86) PCT No.: PCT/KR2023/004909

§ 371 Date: Oct. 21, 2024

(30) Foreign Application Priority Data
Apr. 20, 2022 (KR) 1020220049162
Mar. 23, 2023 (KR) 1020230038159

(51) Int. Cl. F04C 29/00; F04C 18/02; F04C 23/02; H02K 7/04

(52) U.S. Cl. CPC F04C 29/0021; F04C 23/02; H02K 7/04; F04C 18/0215; F04C 2240/40; F04C 2240/807; F04C 2240/808

(57) ABSTRACT

A rotor and an electric compressor equipped with the rotor, the compressor including a housing, a compression unit disposed within the housing, a motor unit installed in the housing to drive the compression unit, an inverter unit coupled to one side of the housing to control the motor unit, wherein the motor unit includes a rotor coupled to a rotating shaft to rotate and generate magnetic flux and a stator positioned radially outward from the rotor, the rotor including a rotor core into which a permanent magnet is inserted and a balance weight module including a plurality of balance weight plates assembled together and attached to at least one of the front or rear side of the rotor core, the compressor makes it possible for the balance weight module to maintain the modular assembly state, thereby minimizing issues related to storage, assembly, and deformation.

### CROSS REFERENCE TO RELATED PATENT APPLICATIONS

This is a U.S. national phase patent application of PCT/KR2023/004909 filed Apr. 12, 2023, which claims the benefit of and priority to Korean Patent Application No. 10-2023-0038159 filed on Mar. 23, 2023, and Korean Patent Application No. 10-2022-0049162 filed on Apr. 20, 2022, the entire contents of each of which are incorporated herein by reference for all purposes.

### TECHNICAL FIELD

The present invention relates to an electric compressor, and more particularly, to an electric compressor equipped with a motor unit capable of reducing vibration.

### BACKGROUND ART

Generally, compressors are responsible for compressing refrigerants in vehicle air conditioning systems and have been developed in various forms. Recently, as part of low-emission, high-efficiency measures, hybrid vehicles that draw power from both an engine and an electric motor have gained significant attention.

With the development of these hybrid vehicles, the trend in vehicle air conditioning systems has gradually shifted from widely used mechanical compressors to electric compressors.

Electric compressors consist of an electric motor, which converts electrical energy into mechanical energy, and an inverter that controls the rotation of the electric motor. Typically, the electric motor in such electric compressors includes a cylindrical rotor and a stator wound with coils surrounding the rotor.

When current flows through the coil due to the power supplied by the inverter, the rotor rotates, and its rotational force is transmitted to the rotating shaft, which then drives mechanical means to perform reciprocating or rotational motion, thereby compressing the refrigerant.

In conventional electric compressors operating in this manner, balance weights are mounted on the front and rear of the rotor.

These balance weights are provided to prevent vibration caused by weight deviations when the rotor rotates at high speeds.

Traditionally, balance weights have been manufactured by stacking multiple laminated plates with a specific curvature and riveting them together, but issues arose during assembly where the laminated plates tended to separate from each other, posing difficulties in stable management.

Additionally, the lack of precise modularization in the number and height of these laminated plates has led to inconvenience in practical use, necessitating a solution to address these issues.

### SUMMARY

The preferred embodiments aim to provide an electric compressor capable of ensuring stable operation and improving the operational process efficiency by installing a balance weight module made of heterogeneous materials.

An electric compressor according to an embodiment of the present invention includes a housing, a compression unit disposed within the housing, a motor unit installed rotatably at the center of the housing to drive the compression unit, an inverter unit coupled to one side of the housing to control the motor unit, wherein the motor unit includes a rotor coupled to a rotating shaft to rotate and generate magnetic flux and a stator positioned radially outward from the rotor, the rotor including a rotor core into which a permanent magnet is inserted and a balance weight module including a plurality of balance weight plates assembled together and attached to at least one of the front or rear side of the rotor core.

The balance weight plates include a first balance weight plate adhered to the peripheral surface of the rotor core and a second balance weight plate adhered to the first balance weight plate.

At least one of the balance weight plates is made of a different material from the remaining balance weight plates.

The coupling structure includes a plurality of first receptacles formed on a surface of the first balance weight plate facing the second balance weight plate, a plurality of protrusions protruding from a surface of the second balance weight plate facing the first balance weight plate, and a plurality of second receptacles concavely formed on the opposite surface of the protrusions.

The protrusions and the first and second receptacles are formed simultaneously in a single process.

The balance weight module, based on being attached at least one of the front or rear side of the rotor core, is symmetrically arranged relative to the rotating shaft, the protrusions are positioned symmetrically about the rotating shaft.

The first balance weight plate includes a first insertion hole formed adjacent to the first receptacles, and the second balance weight plate includes a second insertion hole formed adjacent to the second receptacles.

The first insertion hole is formed at a location where the distance between the outer diameter of the first balance weight plate and the outer diameter of the first insertion hole is equal to or greater than the thickness t1 of the first balance weight plate.

The first insertion hole is formed at a location where the distance between the inner diameter of the first balance weight plate and the outer diameter of the first insertion hole is equal to or greater than the thickness t1 of the first body part.

The first and second balance weight plates have an outer diameter that is maintained smaller than or equal to the outer diameter of the rotor core.

The first balance weight plate is formed from a magnetic metal alloy, and the second balance weight plate is formed from a non-magnetic metal alloy.

The protrusions are formed at locations where the distance between the outer diameter of the protrusion and the outer diameter of the fixing member inserted into the first insertion hole via the second insertion hole is maintained equal to or greater than the thickness t2 of the second balance weight plate.

The protrusions are formed at locations where the distance between the inner diameter of the second balance weight plate and the outer diameter of the protrusion is maintained equal to or greater than the thickness t2 of the second balance weight plate.

The first balance weight plate is formed with a thickness different from that of the second balance weight plate.

The plurality of balance weight plates are fixed to the rotor core via a fixing member securing the outer surfaces of the plurality of balance weight plates to the rotor core.

The preferred embodiments are advantageous in terms of facilitating the manufacture and transportation of a rotor and improving operational efficiency in the production process by producing the rotor with a single balance weight module assembled through press-fitting, unlike conventional balance weights.

The preferred embodiments are also advantageous in terms of eliminating the risk of material inclusion and ensuring a robust coupling by employing a press-fitting method for balance weight module assembly.

The preferred embodiments are also advantageous in term of minimizing deformation caused by riveting the coupling structure by optimizing the arrangement between the fixing members and protrusion parts and the thickness of the first and second balance weight plates.

### DESCRIPTION OF DRAWINGS

FIG. 1 is a perspective view illustrating an electric compressor according to a preferred embodiment;

FIG. 2 is a longitudinal cross-sectional view of FIG. 1;

FIG. 3 is a perspective view illustrating a balance weight module installed on a rotor core according to a preferred embodiment;

FIG. 4 is an exploded perspective view of a balance weight module according to a preferred embodiment;

FIG. 5 is a partial perspective view illustrating the assembly of FIG. 4;

FIG. 6 is a perspective view of the assembly of FIG. 4;

FIG. 7 is a front view illustrating the positions of first insertion holes formed in the first balance weight plate according to a preferred embodiment;

FIGS. 8 and 9 are front view illustrating the positional relationship between fixing members and protrusion parts coupled with a second weight plate according to a preferred embodiment; and

FIG. 10 is a partial perspective view illustrating a balance weight module according to another preferred embodiment of the present invention.

### DESCRIPTION OF AN EMBODIMENT

Advantages and features of the present disclosure and methods of accomplishing the same may be understood more readily by reference to the detailed description of embodiments that will be made hereinafter with reference to the accompanying drawings. The present disclosure may, however, be embodied in many different forms and should not be construed as being limited to the exemplary embodiments set forth herein; rather, these exemplary embodiments are provided so that this disclosure will be thorough and complete and will fully convey the concept of the invention to those skilled in the art, and the present disclosure will only be defined by the appended claims. Throughout the specification, the same reference numerals refer to the same components.

When a component is described as “connected to” or “coupled to” another component, it can refer to a direct connection or coupling with the other component, or to a case where another component is interposed therebetween. Meanwhile, when a component is referred to as “directly connected to” or “directly coupled to” another component, it indicates that there is no other component interposed therebetween. The expression “and/or” is taken to include each of the mentioned items and any combination of one or more.

The terminology used in this specification is for the purpose of describing embodiments, and is not intended to limit the present disclosure. In this specification, the singular form includes the plural form unless otherwise specified in the phrase. The “comprises” and/or “comprising” used in the specification do not preclude the presence or addition of one or more other components, steps, operations, and/or devices mentioned.

Although the terms “first,” “second,” and the like are used for describing various components, these components are not confined by these terms. These terms are merely used for distinguishing one component from the other components.

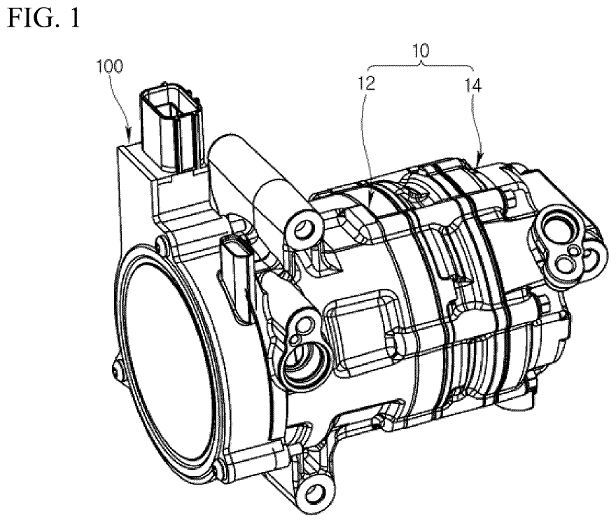

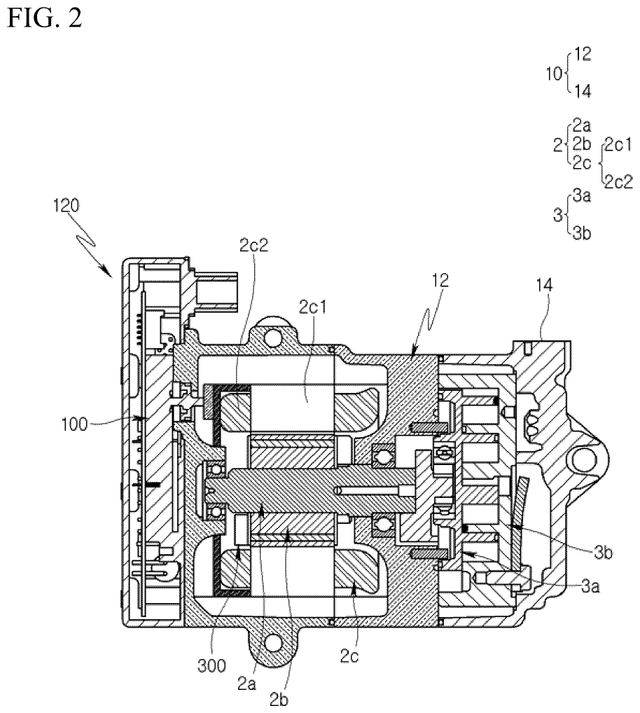

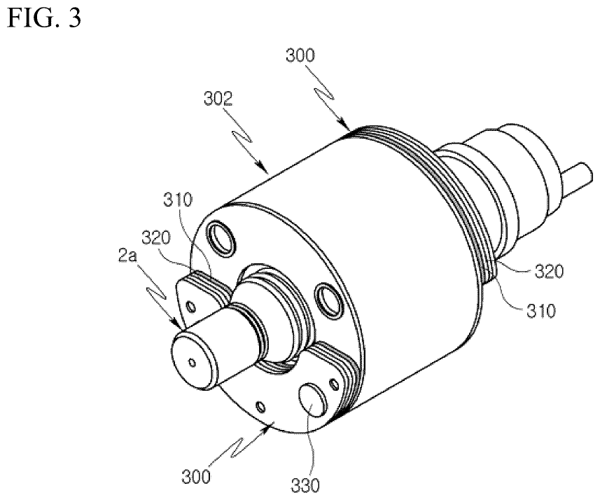

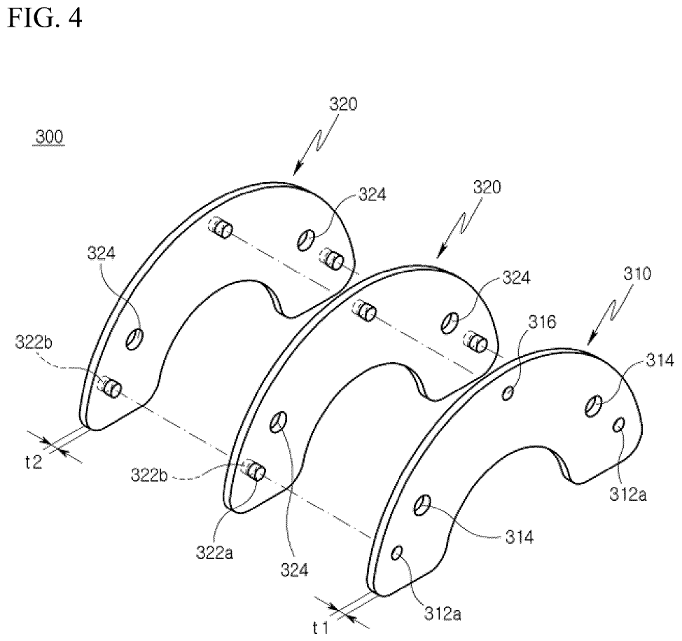

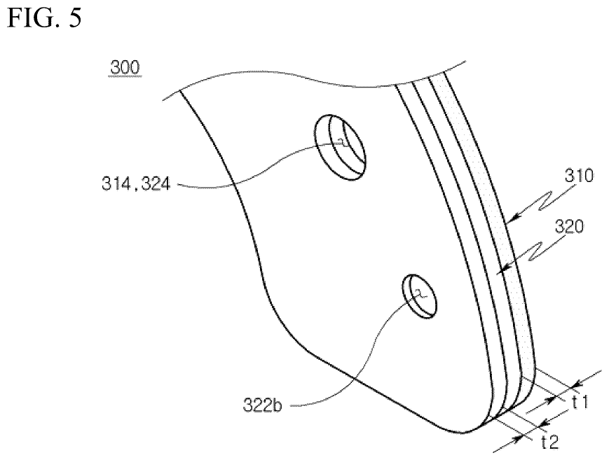

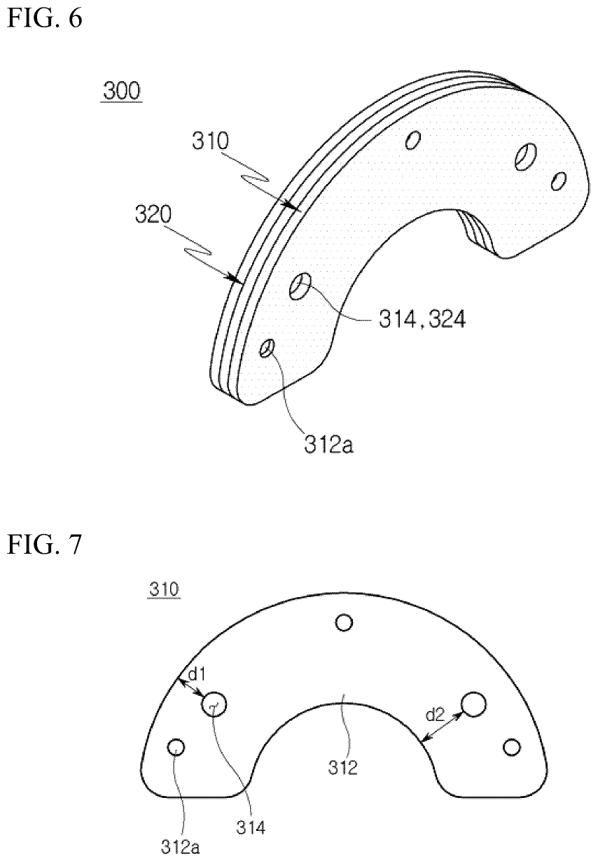

FIG. 1 is a perspective view illustrating an electric compressor according to a preferred embodiment, FIG. 2 is a longitudinal cross-sectional view of FIG. 1, FIG. 3 is a perspective view illustrating a balance weight module installed on a rotor core according to a preferred embodiment, FIG. 4 is an exploded perspective view of a balance weight module according to a preferred embodiment, FIG. 5 is a partial perspective view illustrating the assembly of FIG. 4, and FIG. 6 is a perspective view of the assembly of FIG. 4.

With reference to FIGS. 1 to 6, the electric compressor according to this embodiment includes a housing 10, a compression unit 3 provided within the housing 10, a motor unit 2 housed within the housing 10 to drive the compression unit 3, and an inverter unit 100 coupled to one side of the housing 10 to control the motor unit 2. The motor unit 2 includes a rotor coupled with the rotating shaft 2a and provided with balance weight modules 300 respectively on the front and rear sides thereof.

Alternatively, the rotor may also be configured to have balance weight modules 300 made of different materials installed on the front and rear sides, while maintaining the same configuration for the housing 10, compression unit 3, motor unit 2, and inverter unit 100 as described above.

In this embodiment, the balance weight modules 300 are composed of a plurality of parts that are combined and laminated with each other into the form of a single layered module. These balance weight modules 300 may be modularized for easy transportation to separate loading areas, enhancing storage convenience, and improving operational efficiency for workers at assembly sites.

These modularized balance weight modules 300, when manufactured in this manner, may be conveniently assembled by operators onto electric compressors.

The housing 10 forms the overall exterior of the electric compressor and is composed of a front housing 12 and a rear housing 14 in this embodiment.

The motor unit 2 is housed within the front housing 12 and provides power for compressing the refrigerant in the compression unit 3. The motor unit 2 includes a rotor 2b coupled to a rotating shaft 2a rotatably installed at the center of the front housing 12, and a stator 2c fixed to the front housing 12 and arranged radially outward from the rotor 2b. The stator 2c includes a stator core 2c1 and a stator coil 2c2 wound around the stator core 2c1.

The compression unit 3 is housed within the rear housing 14 and includes an orbital scroll 3a coupled to the rotating shaft 2a via an eccentric bushing and a static scroll 3b fixed between the front housing 12 and rear housing 14 to form compression chambers where refrigerant compression occurs with the orbital scroll 3a.

As a result of the compression unit 3 being connected to the motor unit 2 via the rotating shaft 2a, the rotational power generated by the motor unit 2 may be transmitted to the orbital scroll 3a of the compression unit through the rotating shaft 2a.

The inverter unit 100 is located on the exterior of the housing 10, on the opposite side from the compression unit 3, relative to the motor unit 2. The inverter unit 100 is electrically connected to the motor unit 2, supplying power and control signals received from the outside to the motor unit 2 and controlling the operation of the motor unit 2.

In more detail, the stator 2c forms an electromagnetic field powered by the inverter unit 100, and as the rotor 2b rotates due to the electromagnetic field generated by the stator 2c, rotational power is generated to drive the compression unit 3.

The inverter unit 100 includes a printed circuit board equipped with switching devices and an inverter cover 120 attached to the housing 10 to enclose the printed circuit board.

The inverter unit 100 is attached to one side of the front housing 12, with the inverter body 100 and the inverter cover 120 are sequentially assembled relative to the front housing 12.

The inverter unit 100 is electrically connected to the motor unit, supplying power and control signals received from the outside to power and control the motor unit.

In more detail, the stator 2c forms an electromagnetic field powered by the inverter unit 100, and as the rotor 2b rotates due to the electromagnetic field generated by the stator 2c, rotational power is generated to drive the compression unit 3.

The rotor 2b includes a rotor core 302 into which permanent magnets are inserted, and on at least one side, either the front or the rear of the rotor core 302, a plurality of balance weight plates are assembled and coupled together to form a combined balance weight module 300.

The motor unit 2 and the inverter unit 100 may be electrically connected by a terminal unit. In this embodiment, since a 3-phase motor is used, three connection pins and three terminals (not shown) connected to each of the three phases may be provided on the printed circuit board to supply 3-phase power from the inverter unit 100 to the motor unit.

Each of the three connection pins is connected to the 3-phase coils of the stator, extends through the front housing 12, and protrudes to the inside of the inverter unit 100. Each connection pin protruding inside the inverter unit 100 penetrates the printed circuit board of the inverter unit 100 and is electrically connected to the printed circuit board 200 through respective terminals.

In the electric compressor configured as described the balance weight modules 300 made of different materials are installed on the front and rear of the rotor coupled with the rotating shaft 2a.

The balance weight module 300 according to this embodiment is assembled in a stacked state through press-fitting between pre-machined holes and protrusions on the first and second balance weight plates 310 and 320 to be described later, formed using molding equipment (not shown), allowing it to be produced in a pre-assembled module form for delivery or storage before actual installation in the electric compressor.

The balance weight module 300 includes a plurality of balance weight plates sequentially coupled to the peripheral surface of the rotor core 302 and a coupling structure to facilitate interconnection between these plates.

The balance weight plates include a first balance weight plate 310 adhered to the peripheral surface of the rotor core 302 and a second balance weight plate 320 adhered to the first balance weight plate 310. The first and second balance weight plates 310 and 320 may be formed in an arc shape as an example, with the possibility of being modified into other shapes as well.

In this embodiment, at least one of the plurality of weight plates may be mad of a different material from the remaining balance weight plates; for example, the first balance weight plate 310 may be formed from a different material than the second balance weight plate 320.

The plurality of balance weight plates are fixed to the rotor core 302 via the fixing members 330 that secure the outer surfaces of the plurality of balance weight plates to the rotor core 302. The fixing members 330 may be rivets as an example, though bolts may also be used.

The balance weight module 300 is structured with the first balance weight plate 310 and second balance weight plate 320 composed of different materials to minimize leakage current that may occur from the rotor core 302, promoting stable operation of the motor unit 2.

The first balance weight plate 310 may be made of a magnetic metal material like copper that has a high density per unit volume, but other high-density, current-leakage-resistant materials may also be used to achieve the desired weight.

In particular, when the first balance weight plate 310 is made of copper and directly adheres to the outer circumference of the rotor core 302, it is possible to improve electrical insulation performance.

The second balance weight plate 320, combined with the first balance weight plate 310, may be made of non-magnetic metal materials, with stainless steel being used as an example considering weight and density, although other materials may also be possible.

The coupling structure according to this embodiment includes a plurality of first receptacles 312a formed on the opposite surface of the first balance weight plate 310 and facing the second balance weight plate 320, a plurality of protrusions 322a formed on the second balance weight plate 320 and protruding from the surface facing the first balance weight plate 310, and two receptacles 322b formed concavely on the opposite side (rear side of the second balance weight plate) of the protrusions 332a.

The first receptacles 312a are formed at three positions on the outer front side of the first balance weight plate 310, i.e., left, right, and center-upper positions, such that when combining with protrusions 332a on the second balance weight plate 320, the protrusions 332a are press-fitted into the first receptacles 312a, maintaining a stable and non-detachable coupling state at predetermined locations.

The first receptacles 312a are processed using molding equipment, and, for example, may be easily shaped inwardly at once through press processing.

The first balance weight plate 310 also includes first insertion holes 314 formed adjacent to the first receptacles 312a. The first insertion hole 314 is formed symmetrically left and right, and a first auxiliary insertion hole 316 with a different diameter from the first insertion holes 314 formed between the first insertion holes 314. The first auxiliary insertion hole 316 will be explained later when describing the second balance weight plate 320.

The first insertion holes 314 are opened to allow the insertion of a fixing members 330, which will be described later, and are symmetrically formed on the left and right sides of the first balance weight plate 310.

The first and second balance weight plates 310 and 320 have an outer diameter that is equal to or smaller than the outer diameter of the rotor core 302, preventing any radial protrusion when installed on the rotor core 302, thereby satisfying the limited layout inside the electric compressor while ensuring stable operation.

The second balance weight plate 320, unlike the first balance weight plate 310, is composed of n number of plates, which may be two as shown in the drawing as an example, but the number may be varied and is not limited to the number shown in the drawing.

The second balance weight plate 320 has a plurality of protrusions 322a formed on the surface facing the first balance weight plate 310 and second receptacles 322b formed concavely on the opposite surface of the protrusions 322a. Additionally, adjacent to the protrusions 322a, second insertion holes 324 are formed for the insertion of fixing members 330.

The second insertion holes 324 are opened for the insertion of the fixing members 330 and are symmetrically arranged on the left and right sides of the second balance weight plate 320.

The protrusions 322a are formed at three positions on the left, right, and upper-center, when viewed from the outer front side of the second balance weight plate 320, ensuring stable coupling with the first balance weight plate 310 without detachment at predetermined positions when combined. Since the second insertion holes 324 are positioned in the same location as the first insertion hole 314, when the first balance weight plate 310 and the second balance weight plate 320 are assembled in close contact with each other, the first and second insertion holes 314 and 324 align perfectly, facilitating convenient assembly.

The protrusions 322a are processed using molding equipment, for example, through press processing.

The protrusions 322a are formed simultaneously during the molding process of the second receptacles 322b using equipment such as press processing, where pressure is applied to shape the second receptacles 322b, and on the opposite side (front) of the second body part 322, protrusions 322a are formed.

That is, the protrusions 332a and the first and second receptacles 312a and 322b may be formed simultaneously in a single process, enhancing worker efficiency and streamlining the manufacturing process for mass production.

Therefore, the protrusions 332a and the first and second receptacles 312a and 322b may be formed by adjusting the pressure in the press process as shown in the drawings.

Moreover, forming the protrusions 322a and the second receptacles 322b together in a single processing step enhances worker efficiency.

The second balance weight plate 320 according to this embodiment may be provided in plurality, and a second balance weight plate 320 with the same structure as the one provided on the rear of the first balance weight plate 310 is sequentially coupled through insertion into the second receptacles 322b.

The balance weight module 300, when installed on either the front or rear side of the rotor core 302, is arranged symmetrically about the rotating shaft 2a, taking the form of a flat plate shaped like a semi-circular disk, for example. Additionally, the protrusions 322a are positioned symmetrically about the rotating shaft 2a, for example, on the left and right sides respectively when viewed from the outside of the balance weight module 300.

The first and second balance weight plates 310 and 320 configured as such are brought together with the second balance weight plate 320 facing the first balance weight plate 310, and the protrusions 322a are inserted into the first receptacles 312a, thereby joining the plates together.

The first and second balance weight plates 310 are 320 are ultimately fixed to the rotor core 302 through the fixing members 330. Rivets are used for the fixing members 330, but other materials may also be used for stable fixation.

With reference to FIG. 7, in this embodiment, the first insertion holes 314 are positioned such that the distance d1 between the outer diameter of the first balance weight plate 310 and the outer diameter of the first insertion holes 314 is relatively equal to or greater than the thickness t1 of the first balance weight plate 310.

In this embodiment, when coupling the first and second balance weight plates 310 and 320 using fixing members 330, gaps may occur as the first and second balance weight plates settle during assembly.

To prevent this, in this embodiment, the distance d1 between the outer diameter of the first balance weight plate 310 and the outer diameter of the first insertion hole 314 is maintained relatively equal to or greater than the thickness t1 of the first balance weight plate 310, as described above, which may prevent problems such as misassembly, operational noise or vibration, and reduced durability.

When the first insertion hole 314 is positioned, deformation due to processing is minimized, and even after assembly onto the rotor core 302, deformation can be minimized when stress is concentrated through the coupling structure.

In this embodiment, the first insertion holes 314 are positioned such that the distance d2 between the inner diameter of the first balance weight plate 310 and the outer diameter of the first insertion holes 314 is relatively equal to or greater than the thickness t1 of the first balance weight plate 310.

Positioning the first insertion hole 314 at a distance greater than the thickness t1 from both the outer diameter and inner diameter of the first balance weight plate 310 minimizes deformation caused by processing and subsequent stress concentration when the fixing member 330 is attached after assembly to the rotor core 302.

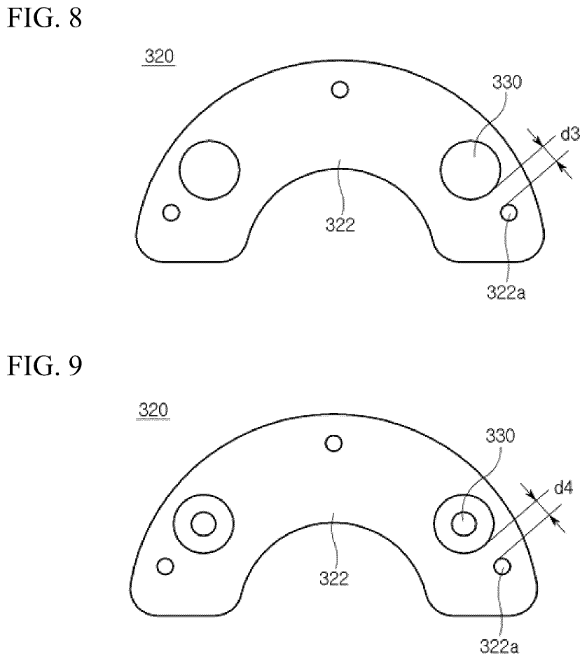

With reference to FIGS. 8 and 9, the second balance weight plate 320 according to this embodiment maintains a distance d3 between the outer diameter of the fixing member 330 and the outer diameter of the protrusion 322a to be equal to or greater than the thickness t2 of the second balance weight plate 320.

Positioning the second insertion hole 324 in the second balance weight plate 320 as such minimizes deformation during processing and subsequent stress concentration when the fixing member 330 is attached after assembly to the rotor core 302.

The distance between the inner diameter of the second balance weight plate 320 and the outer diameter of the protrusion 322a is maintained be greater than the thickness t2 of the second balance weight plate 320.

This may minimize deformation caused during processing and subsequent stress concentration when the fixing member 330 is attached after assembly to the rotor core 302.

In this embodiment, as shown in FIG. 9, even when the fixing member 330 is riveted, the distance d4 between the outer diameter of the riveted fixing member 330, as shown in FIG. 8, and the outer diameter of the protrusion 322a is maintained at a distance relatively greater than the thickness t2 of the second balance weight plate 320.

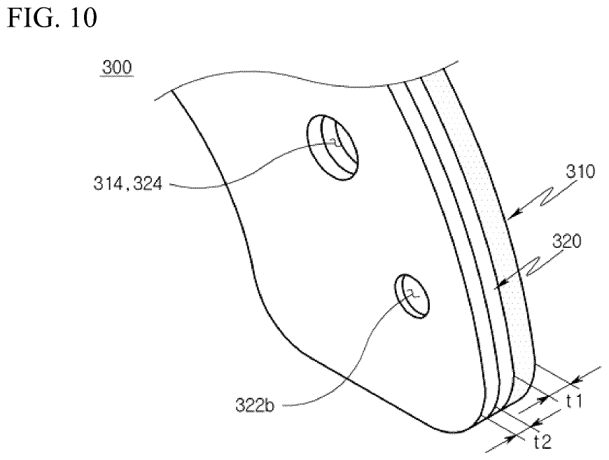

With reference to FIG. 10, the first balance weight plate 310 according to this embodiment may be formed with a thickness different from that of the second balance weight plate 320.

For example, by forming the first balance weight plate 310 relatively thicker than the second balance weight plate 320, it becomes possible to prevent current leakage to the rotor core 302.

The first balance weight plate 310 may be formed to be 50% thicker than the second balance weight plate 320, thereby minimizing vibration resulting from the operation of the motor unit 2.

Although the description has been made with example embodiments of the present invention, those skilled in the art will appreciate that various modifications and changes, such as addition, alteration, and deletion of components, can be made to the present invention without departing from the spirit and scope of the invention as set forth in the appended claims, and such modifications and changes are also included within the scope of the invention.

The preferred embodiments may be used in vehicles equipped with electric compressors that include installed balance weight modules.

1-15. (canceled)

16. An electric compressor comprising:
a housing;
a compression unit disposed within the housing;
a motor unit installed rotatably at a center of the housing to drive the compression unit; and
an inverter unit coupled to one side of the housing to control the motor unit,
wherein the motor unit further comprises
a rotor coupled to a rotating shaft to rotate and generate magnetic flux, and
a stator positioned radially outward from the rotor,
the rotor further comprising
a rotor core into which a permanent magnet is inserted, and
a balance weight module further comprising a plurality of balance weight plates assembled together and attached to at least one of a front side or a rear side of the rotor core.

17. The electric compressor of claim 16, wherein the balance weight plates further comprise a first balance weight plate adhered to a peripheral surface of the rotor core and a second balance weight plate adhered to the first balance weight plate.

18. The electric compressor of claim 16, wherein at least one of the balance weight plates is made of a different material from remaining ones of the balance weight plates.

19. The electric compressor of claim 17, wherein a coupling structure comprises:
a plurality of first receptacles formed on a surface of the first balance weight plate facing the second balance weight plate;
a plurality of protrusions protruding from a surface of the second balance weight plate facing the first balance weight plate; and
a plurality of second receptacles concavely formed on an opposite surface of the protrusions.

20. The electric compressor of claim 19, wherein the protrusions and the first receptacles and the second receptacles are formed simultaneously in a single process.

21. The electric compressor of claim 19, wherein the balance weight module, based on being attached to at least one of the front side or the rear side of the rotor core, is symmetrically arranged relative to the rotating shaft, the protrusions are positioned symmetrically about the rotating shaft.

22. The electric compressor of claim 19, wherein the first balance weight plate further comprises a first insertion hole formed adjacent to the first receptacles, and the second balance weight plate further comprises a second insertion hole formed adjacent to the second receptacles.

23. The electric compressor of claim 22, wherein the first insertion hole is formed at a location where a distance between an outer diameter of the first balance weight plate and an outer diameter of the first insertion hole is equal to or greater than a thickness t1 of the first balance weight plate.

24. The electric compressor of claim 22, wherein the first insertion hole is formed at a location where a distance between an inner diameter of the first balance weight plate and an outer diameter of the first insertion hole is equal to or greater than a thickness t1 of a first body part.

25. The electric compressor of claim 17, wherein the first balance weight plate and the second balance weight plate have an outer diameter being maintained smaller than or equal to an outer diameter of the rotor core.

26. The electric compressor of claim 17, wherein the first balance weight plate is formed from a magnetic metal alloy, and the second balance weight plate is formed from a non-magnetic metal alloy.

27. The electric compressor of claim 22, wherein the protrusions are formed at locations where a distance between an outer diameter of each of the protrusions and an outer diameter of a fixing member inserted into the first insertion hole via the second insertion hole is maintained equal to or greater than a thickness t2 of the second balance weight plate.

28. The electric compressor of claim 27, wherein the protrusions are formed at locations where a distance between an inner diameter of the second balance weight plate and the outer diameter of each of the protrusions is maintained equal to or greater than the thickness t2 of the second balance weight plate.

29. The electric compressor of claim 17, wherein the first balance weight plate is formed with a thickness different from a thickness of the second balance weight plate.

30. The electric compressor of claim 16, wherein the plurality of balance weight plates is fixed to the rotor core via a fixing member securing outer surfaces of the plurality of balance weight plates to the rotor core.
